(19) United States
(12) Patent Application Publication
(10) Pub. No.: US 2025/0003748 A1
(43) Pub. Date: Jan. 2, 2025

(54) Tilt Sensor and Detecting System

(71) Applicant: Nippon Telegraph and Telephone Corporation, Tokyo (JP)

(72) Inventors: Hiroaki Taguchi, Musashino-shi, Tokyo (JP); Takeshi Komatsu, Musashino-shi, Tokyo (JP); Mikayo Iwata, Musashino-shi, Tokyo (JP); Masaya Nohara, Musashino-shi, Tokyo (JP); Shuhei Sakamoto, Musashino-shi, Tokyo (JP); Sho Okubo, Musashino-shi, Tokyo (JP)

(21) Appl. No.: 18/710,970

(22) PCT Filed: Nov. 22, 2021
(86) PCT No.: PCT/JP2021/042800

§ 371 Date: May 16, 2024

(51) Int. Cl. G01C 9/18; G01C 9/06; H01M 6/12

(52) U.S. Cl. CPC G01C 9/18; G01C 9/06; H01M 6/12; G01C 2009/182

(57) ABSTRACT

An inclination sensor includes a notification unit that notifies occurrence of inclination of a structure, a water storage tank that contains an electrolytic solution, and a primary battery including a positive electrode, a negative electrode, and a separator disposed between the positive electrode and the negative electrode. In the inclination sensor, when the water storage tank is inclined with the inclination of the structure, an electrolytic solution is injected into the separator, and the primary battery starts power generation and supplies electric power necessary for driving the notification unit.

### TECHNICAL FIELD

The present invention relates to an inclination sensor and a detection system.

### BACKGROUND ART

In construction of infrastructure in Japan, about 360 million structures such as utility poles are laid. The utility poles are used for installation of transmission and distribution cables by power companies and communication cables by communication companies. To properly operate the infrastructure, workers confirm that there is no inclination or collapse due to typhoons, earthquakes, aging, or the like by visual inspection of an appearance or the like (see Non Patent Literatures 1 and 2).

A total inspection of the structure is performed in a planned manner by visual inspection. Deterioration or abnormality of basic equipment that supports communication is observed. The deterioration of the basic equipment is performance degradation cracking that progresses with the lapse of time, such as corrosion of steel material or neutralization of concrete. The abnormality of the basic equipment is superficial abnormality such as deflection, deformation, peeling, and rust. The degree or scale of the deterioration of the basic equipment is grasped, and the basic equipment is repaired, reinforced, or renewed as necessary.

In recent years, social demands for ensuring safety of social infrastructures tend to increase. There is a concern about an increase in frequency and items of inspection and an increase in inspection cost due to aging of structures (see Non Patent Literature 2).

To reduce inspection operation, techniques for reducing the inspection operation using an Internet of Things (IoT) device has been studied. As one of outdoor installation-type sensors that detect inclination of a structure such as a utility pole, there are collapse detection sensors using specified low power radio (see Non Patent Literatures 3 and 4). The collapse detection sensors described in Non Patent Literatures 3 and 4 measure the inclination at specified intervals, and when the inclination exceeds a threshold value, the collapse detection sensors notify the inclination by power saving wide area wireless communication.

Disposable primary batteries are used to operate these sensors. As disposable primary batteries, small and high-performance lithium ion batteries corresponding to various applications have been widely used in addition to alkaline batteries, manganese batteries, and air batteries.

The above-described batteries generate self-discharge because electrodes are in contact with an electrolytic solution. Further, since a strongly alkaline electrolytic solution such as a sodium hydroxide aqueous solution or an organic electrolytic solution is used as the electrolytic solution, problems with safety and environment have been pointed out, and there is a problem that handling is not easy.

To solve the above-described problems, a type of battery in which an electrolytic solution is injected into a battery cell at the time of use is known. Further, as an emergency battery for long-term storage, there is a battery that operates by injecting an electrolytic solution into a battery cell (see Non Patent Literature 5). This battery can be stored for a long period of time in a state where no electrolytic solution is injected.

### CITATION LIST

### Non Patent Literature

Non Patent Literature 1: Resource and Energy Agency, “Promotion of pole elimination from the viewpoint of enhancing power resilience”, [online], [searched on Sep. 15, 2021], Internet <URL: https://www.meti.go.jp/shingikai/enecho/denryoku_gas/denryoku_gas/pdf/035_04_00.pdf>
Non Patent Literature 2: Nippon Telegram Co., Ltd., “NTT Technical Journal 2014.08”, [online], [searched on Sep. 15, 2021], Internet <URL: https://www.ntt.co.jp/journal/1408/files/jn201408022.pdf>
Non Patent Literature 3: Toppan Forms Co., Ltd., “Inclination monitoring system”, [online], [searched on Sep. 15, 2021], Internet <URL: https://rfid.toppan-f.co.jp/solve/inclination.html>
Non Patent Literature 4: Nishimatsu Construction Co., Ltd, “Slope inclination monitoring cloud system”, [online], [searched on Sep. 15, 2021], Internet <URL: https://www.nishimatsu.co.jp/solution/okippa104/>
Non Patent Literature 5: Aqua Power System Japan, “NOPOPO water battery for disaster” [online], [searched on Mar. 17, 2021], Internet <URL: http://www.aps-j.jp/pdf/NWPx3.pdf>

### SUMMARY OF INVENTION

### Technical Problem

However, in the sensors described in Non Patent Literature 1 and Non Patent Literature 2, a mechanism for detection and notification always operates, and requires periodic replacement of the internal battery.

The battery described in Non Patent Literature 5 is used by a person injecting the electrolytic solution. Therefore, the battery described in Non Patent Literature 5 cannot supply power in a situation where a person cannot be involved, such as when the battery is installed and used at a high place or in nature.

In this way, there is no mode for supplying power for notification in response to detection by the sensor.

The present invention has been made in view of the above circumstances, and an object of the present invention is to provide a technique capable of providing power for notification in response to detection by a sensor.

### Solution to Problem

An inclination sensor according to one aspect of the present invention includes a notification unit configured to notify occurrence of inclination of a structure, a water storage tank configured to contain an electrolytic solution, and a primary battery including a positive electrode, a negative electrode, and a separator disposed between the positive electrode and the negative electrode, in which, when the water storage tank is inclined with the inclination of the structure, the electrolytic solution is injected into the separator, and the primary battery starts power generation and supplies power necessary for driving the notification unit.

A detection system according to one aspect of the present invention includes the inclination sensor and a detection server connected to the inclination sensor, and configured to detect a notification of the inclination sensor and refer to a unique identifier of the inclination sensor and an installation position of the inclination sensor, in which the notification unit of the inclination sensor notifies the unique identifier of the inclination sensor, and the detection server outputs a number of the notified unique identifiers and the installation position of the inclination sensor specified from the notified unique identifiers.

### Advantageous Effects of Invention

According to the present invention, it is possible to provide a technique capable of providing power for notification in response to detection by a sensor.

### BRIEF DESCRIPTION OF DRAWINGS

FIG. 1 is a view schematically for describing an internal structure of an inclination sensor according to an embodiment of the present invention in side view.

FIG. 2 is a view for describing a system configuration of a detection system according to the embodiment of the present invention.

FIG. 3 is a flowchart for describing processing of a detection server according to the embodiment of the present invention.

FIG. 4 is a graph illustrating a change over time in battery voltage in the inclination sensor according to the embodiment of the present invention.

FIG. 5 is a diagram illustrating a hardware configuration of a computer used in the detection server.

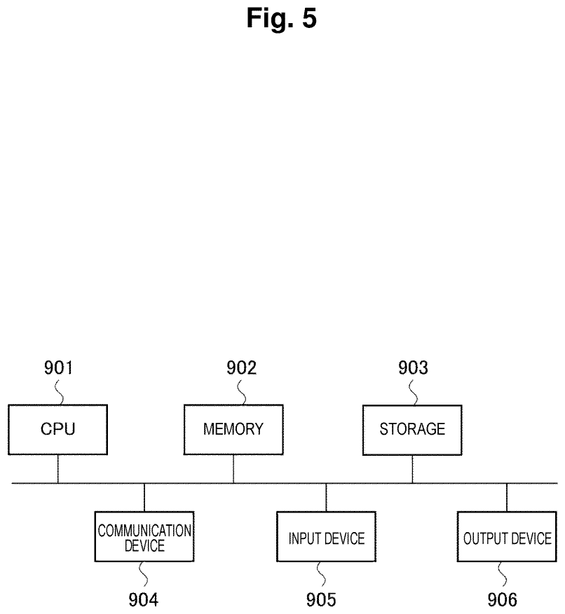

### DESCRIPTION OF EMBODIMENTS

Hereinafter, embodiments of the present invention will be described with reference to the drawings. The same reference signs will be applied to the same components in the description of the drawings, and description will be omitted.

### (Inclination Sensor)

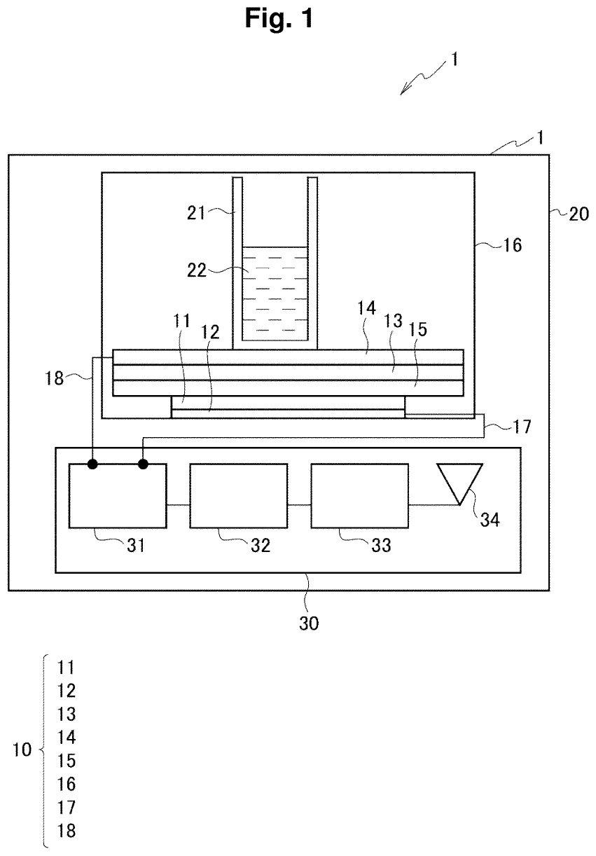

An inclination sensor 1 according to an embodiment of the present invention will be described with reference to FIG. 1. The inclination sensor 1 is installed in a structure such as a utility pole. The inclination sensor 1 detects inclination or collapse of the structure and notifies a detection server 102 of the inclination or collapse. The inclination sensor 1 is fixed to the structure such as a utility pole using, for example, an attachment band. The inclination sensor 1 is favorably installed at a high position of the structure in order to enable inclination of only an upper portion of the structure.

The inclination sensor 1 includes a battery housing 16 and a notification unit 30 in a housing 20. The battery housing 16 includes a primary battery 10 and a water storage tank 21. The primary battery 10 includes a separator 15 between a positive electrode 11 and a negative electrode 13. The water storage tank 21 contains an electrolytic solution 22. In a state where the inclination sensor 1 is installed on the structure, the electrolytic solution 22 is formed so as not to be in contact with the separator 15.

In the inclination sensor 1 according to the embodiment of the present invention, when the water storage tank 21 is inclined with inclination of the structure, the electrolytic solution 22 is injected into the separator 15. When the electrolytic solution 22 comes into contact with the separator 15, water is supplied to the separator 15 by a capillary phenomenon, and the primary battery 10 starts power generation. The primary battery 10 supplies power necessary for driving the notification unit 30. The notification unit 30 notifies the inclination using the power supplied from the primary battery 10.

As described above, since the inclination sensor 1 is driven using the primary battery 10 that generates power when inclined, it is not necessary to operate in normal times, and it is possible to notify the operation only in an emergency. Accordingly, the inclination sensor 1 does not self-discharge when not active, and can be operated for a long period of time such as over 10 years.

The primary battery 10 includes the positive electrode 11, a positive electrode current collector 12, the negative electrode 13, a negative electrode current collector 14, the separator 15, the battery housing 16, a positive electrode current collecting tab 17, a negative electrode current collecting tab 18, the water storage tank 21, and the electrolytic solution 22. The battery housing 16 includes the positive electrode 11, the positive electrode current collector 12, the negative electrode 13, the negative electrode current collector 14, the separator 15, the water storage tank 21, and the electrolytic solution 22. The positive electrode current collecting tab 17 and the negative electrode current collecting tab 18 are exposed from the battery housing 16 and supply power from the primary battery 10 to the notification unit 30.

The arrangement and shape of each member of the positive electrode 11, the positive electrode current collector 12, the negative electrode 13, the negative electrode current collector 14, the separator 15, and the battery housing 16 are not limited as long as they can operate as a battery. For example, the positive electrode 11, the positive electrode current collector 12, the negative electrode 13, the negative electrode current collector 14, the separator 15, and the battery housing 16 may have a quadrangular or circular sheet shape in plan view.

The positive electrode 11 is connected to the positive electrode current collector 12. The negative electrode 13 is connected to the negative electrode current collector 14. The separator 15 is disposed between the positive electrode 11 and the negative electrode 13. A partial surface of the positive electrode 11 is connected to the separator 15.

The positive electrode 11, the positive electrode current collector 12, the negative electrode 13, the negative electrode current collector 14, and the separator 15, which are connected to each other, are sandwiched by the battery housing 16 in an up-down direction, and peripheral edge portions thereof are bonded and integrated, whereby an inside of the primary battery 10 is sealed. Examples of a bonding method include heat sealing and use of an adhesive, and are not particularly limited. For example, in a case where bonding with heat sealing is difficult, an adhesive is used. Air can be taken in by opening a part of the peripheral edge portions without bonding when the inside of the primary battery 10 is sealed.

The positive electrode 11 is of gas diffusion type. Of the surfaces of the positive electrode 11, surfaces other than the surface in contact with the separator 15 are exposed to the atmosphere taken in from a peripheral portion of the battery housing 16 or a hole (not illustrated) provided in the battery housing 16.

The separator 15 is formed of an insulator having water absorbency. Paper such as a coffee filter and a kitchen paper can be used for the separator 15. When a sheet of a material that is naturally decomposed while maintaining strength, such as a cellulose-based separator made of plant fibers, is used as the separator 15, a burden on the environment is reduced even in a case where the inclination sensor 1 is not collected after being installed.

The battery housing 16 may have any configuration as long as the battery housing 16 contains the positive electrode 11, the positive electrode current collector 12, the negative electrode 13, the negative electrode current collector 14, the separator 15, and the water storage tank 21 inside. It is favorable that the inside of battery housing 16 is not impregnated with rain or the like so that the separator 15 is not wetted by rain or the like. The battery housing 16 is favorably formed of, for example, a laminate film.

In the embodiment of the present invention, a case where the battery housing 16 includes the water storage tank 21 will be described, but the present embodiment is not limited thereto. The inclination sensor 1 may be formed in any manner as long as the electrolytic solution 22 can be in contact with the separator 15 when the inclination sensor 1 is inclined. For example, the water storage tank 21 may be provided outside the battery housing 16.

The water storage tank 21 contains the electrolytic solution 22. To have a role of water retention, the electrolytic solution 22 may enclose agar, cellulose, a water-absorbing polymer, or the like. In a state where the inclination sensor 1 is installed on a structure or the like, the water storage tank 21 is installed above the primary battery, and an upper side of the water storage tank 21 is opened. When the structure or the like is inclined, the electrolytic solution 22 in the water storage tank 21 spills through the opening of the water storage tank 21, and the electrolytic solution 22 comes into contact with the separator 15 provided below the water storage tank 21. The electrolytic solution 22 is supplied to the separator 15 by a capillary phenomenon, and the primary battery 10 starts power generation.

In a state where the inclination sensor 1 is installed in a structure, the primary battery 10 is formed of the positive electrode 11, the separator 15, and the negative electrode 13 in this order from a bottom. Even in a case where the water storage tank 21 is inclined, the separator 15 above the positive electrode 11 receives the electrolytic solution 22 in the water storage tank 21. Therefore, the positive electrode 11 can be prevented from coming into contact with the electrolytic solution 22. Further, by setting the amount of the electrolytic solution 22 in the water storage tank 21 to an amount that can be received by the separator 15, the positive electrode 11 can be prevented from coming into contact with the electrolytic solution 22. Further, by controlling the specification of the water storage tank 21 or the amount of the electrolytic solution 22, an inclination angle of the inclination sensor 1 when the electrolytic solution 22 is leached to the separator 15 can be adjusted.

Here, the size of a horizontal surface of the separator 15 is formed to be larger than that of the positive electrode 11. As a result, even in a case where the electrolytic solution 22 spills from the water storage tank 21 due to the inclination of the structure, the separator 15 can receive the electrolytic solution 22 without the positive electrode 11 being in contact with the electrolytic solution 22.

Further, by using a material that is naturally decomposed for the battery housing 16 and the housing 20, the burden on the environment is reduced even in a case where the inclination sensor 1 is not collected. Specifically, the battery housing 16 and the housing 20 are formed of any one or more of polylactic acid, polycaprolactone, polyhydroxyalkanoate, polyglycolic acid, modified polyvinyl alcohol, casein, modified starch, or the like. Among these, it is particularly favorable that the battery housing 16 and the housing 20 be formed of a chemical synthesis system such as plant-derived polylactic acid. The shapes of the battery housing 16 and the housing 20 are obtained by processing such biodegradable plastic. The material applicable to the battery housing 16 and the housing 20 is, for example, any one or more of biodegradable plastic, a film of biodegradable plastic, a sheet on which a film of a resin such as polyethylene is formed, which is used for a milk carton or the like, an agar film, or the like.

In the inclination sensor 1, when the electrolytic solution 22 in the water storage tank 21 comes into contact with the separator 15 due to inclination or collapse of the structure, moisture is taken into the separator 15 by a capillary phenomenon. When the electrolytic solution 22 comes into contact with the positive electrode 11 and the negative electrode 13, the primary battery 10 starts power generation. The primary battery 10 supplies the power to the notification unit 30, so that the notification unit 30 can notify that inclination of the structure has been detected.

The notification unit 30 notifies occurrence of inclination of the structure. In the embodiment of the present invention, a case where the notification unit 30 notifies the detection server 102 of the occurrence of inclination via a wireless communication network will be described. The communication wireless network is mobile communication provided by a mobile communication carrier, specific low power radio conforming to a standard such as Association of Radio Industries and Businesses (ARIB) STD-T67, STD-T93, or STD-T108, or the like. As another notification method, a method of turning on a lamp (not illustrated) provided in the inclination sensor 1 to give a notification when the inclination has occurred is conceivable.

The notification unit 30 includes a power supply circuit 31, an arithmetic circuit 32, a communication circuit 33, and a communication antenna 34. Each of the power supply circuit 31, the arithmetic circuit 32, the communication circuit 33, and the communication antenna 34 is driven by the power supplied from the primary battery 10 at the time of inclination.

The power supply circuit 31 is a direct current to direct current (DCDC) circuit, and converts the power supplied from the primary battery 10 into a voltage that can be used by each circuit. As illustrated in FIG. 1, the positive electrode current collector 12 and the negative electrode current collector 14 are connected to the power supply circuit 31. The power supply circuit 31 converts the power supplied from the positive electrode current collector 12 and the negative electrode current collector 14 into a desired voltage and provides the voltage to each circuit of the notification unit 30. In a case where the power is supplied at a sufficient voltage such as when a plurality of the primary batteries 10 is connected in series and it is not necessary to boost the voltage, the power supply circuit 31 may be omitted. In this case, the power supplied from the positive electrode current collector 12 and the negative electrode current collector 14 is directly provided to each circuit of the notification unit 30.

The arithmetic circuit 32 generates transmission data to the detection server 102 and inputs the transmission data to the communication circuit 33. The transmission data includes an identification number of the inclination sensor 1.

The communication antenna 34 is an interface for being connected to a wireless communication network. The communication circuit 33 communicates with the detection server 102 using the communication antenna 34.

In the inclination sensor 1 according to the embodiment of the present invention, when inclination of the structure has occurred, the primary battery 10 built in the inclination sensor 1 generates power, and notification by the notification unit 30 becomes possible. The inclination sensor 1 does not need to operate in normal times, and can operate only in an emergency and notify the occurrence of inclination. Accordingly, the inclination sensor 1 does not self-discharge when not active, and can be operated for a long period of time such as over 10 years.

Further, each member of the inclination sensor 1 can be formed of a material that is naturally decomposed. Such an inclination sensor 1 is suitably applied to a disposable sensor that is naturally installed. Since the primary battery 10, the housing 20, and the like used for the inclination sensor 1 are naturally decomposed with the lapse of time, it is not necessary to collect the inclination sensor 1. Further, since the inclination sensor 1 is composed of a naturally-derived material or a fertilizer component, the burden on the environment is extremely low.

In the embodiment of the present invention, the case where the inclination sensor 1 includes one primary battery 10 has been described, but the present embodiment is not limited thereto. An inclination sensor 1a may include a plurality of primary batteries 10 connected in series.

### (Detection System)

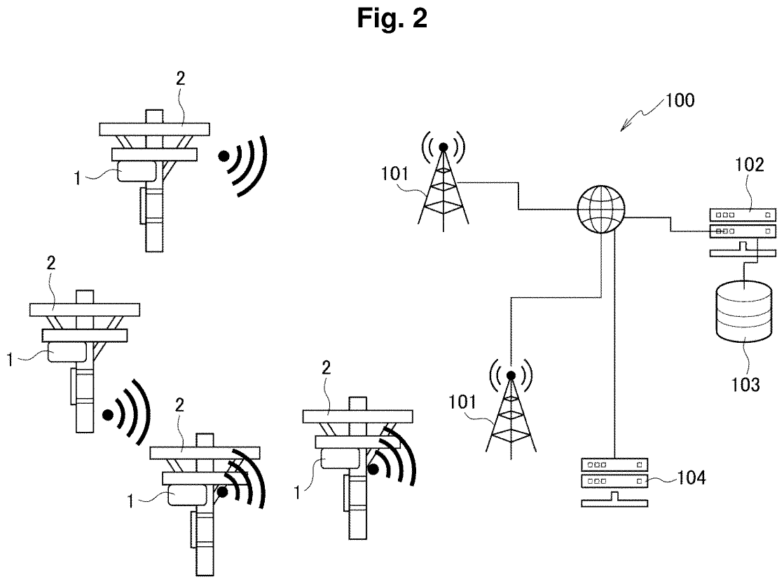

A detection system 100 according to an embodiment of the present invention will be described with reference to FIG. 2. In the detection system 100, the inclination sensor 1 is installed on the structure to be managed by the detection system 100 or a manager of the structure.

The detection server 102 is connected to the inclination sensor 1, detects the notification of the inclination sensor 1, and refers to the unique identifier of the inclination sensor 1 and the installation position of the inclination sensor 1. The notification unit 30 of the inclination sensor 1 notifies the detection server 102 of the unique identifier of the inclination sensor 1. The detection server 102 outputs the number of the notified unique identifiers and the installation positions of the inclination sensors specified from the notified unique identifiers.

The detection server 102 monitors and aggregates the notification from the inclination sensor 1, specifies an occurrence place, a scale, and the like of the inclination of the structure, and provides information to an observer via a monitoring device 104. Note that the system configuration illustrated in FIG. 2 is an example, and is appropriately changed according to the specification of the wireless communication network, the position where the inclination sensor 1 is provided, and the like.

The detection system 100 includes a plurality of the inclination sensors 1, a base station 101, the detection server 102, a database server 103, and the monitoring device 104. The inclination sensor 1 communicates with the detection server 102 via the base station 101.

The base station 101 is connected to the detection server 102 and is wirelessly connected to the inclination sensor 1. The detection server 102 is connected to the plurality of inclination sensors 1 via the base station 101. The database server 103 stores data of the inclination sensor 1, and the detection server 102 can refer to the data stored in the database server 103. The monitoring device 104 may transmit an alarm according to an output from the detection server 102.

The database server 103 associates and holds the unique identification number of the inclination sensor 1 and the position where the inclination sensor 1 is installed. The database server 103 may further associate the inclination angle of the structure notifiable by the inclination sensor 1. The inclination angle is an angle at which the inclination sensor 1 is inclined when the primary battery 10 of the inclination sensor 1 is driven and the notification unit 30 becomes able to give a notification. From the specification of the water storage tank 21 of the inclination sensor 1 and the amount of the electrolytic solution 22 contained in the water storage tank 21, the inclination angle of the structure notifiable by the inclination sensor 1 is specified in advance. The specifications of the water storage tank 21 include a positional relationship between the battery housing 16 and the water storage tank 21, a size of each side of the water storage tank 21, and the like.

For example, when being notified of the inclination from the inclination sensor 1, the detection server 102 is connected to the database server 103, is connected to each of the inclination sensors 1, and refers to the position where the inclination sensor 1 is installed and the inclination angle. The detection server 102 can estimate that the inclination has occurred in a wider range as the number of notified inclination sensors 1 is larger. Further, the detection server 102 can estimate that the damage is larger as the inclination angle notifiable by the notified inclination sensor 1 is larger.

In a case where the notified number, positions, inclination angles, and the like of the inclination sensors 1 match conditions set by the monitoring device 104, the detection server 102 notifies the monitoring device 104. The detection server 102 may notify the monitoring device 104 that the predetermined conditions are satisfied, or may also notify the notified data such as the number, positions, and inclination angles of the inclination sensors 1. Since the monitoring device 104 can grasp the position and situation of the structure in which the inclination has occurred, the administrator can immediately and easily grasp the damage scale and formulate a recovery plan. Further, the monitoring device 104 may notify an observer of a local government or an administrative authority depending on the damage scale. It is possible to call attention to the local government or administrative authority.

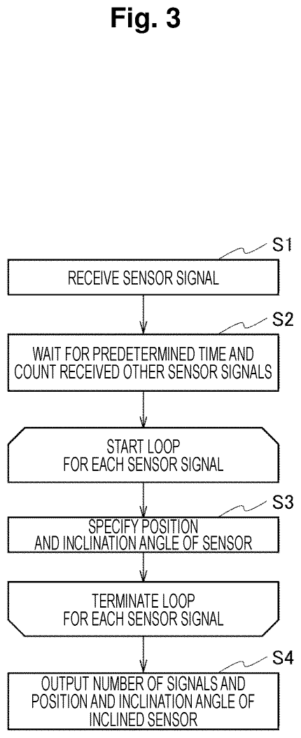

Processing of the detection server 102 will be described with reference to FIG. 3. In the processing illustrated in FIG. 3, when receiving a signal from a certain inclination sensor 1, the detection server 102 waits for and outputs signals from other inclination sensors 1. Note that the processing illustrated in FIG. 3 is an example, and the present embodiment is not limited thereto.

In step S1, when receiving a sensor signal indicating occurrence of inclination from one inclination sensor 1, in step S2, the detection server 102 waits for reception of the sensor signal from another inclination sensor 1 for a predetermined time and counts the sensor signal received in the predetermined time.

The detection server 102 repeats the processing in step S3 for each sensor signal received in steps S1 and S2. In step S3, the detection server 102 refers to the database server 103 for the sensor signal to be processed, and specifies the position where the sensor is installed and the inclination angle.

In step S4, the detection server 102 outputs the number of sensor signals received in steps S1 and S2, and the position and the inclination angle of the inclined sensor. At this time, the detection server 102 may determine whether the conditions set by the monitoring device 104 or the like are satisfied, and may output data designated by the conditions in the case where the conditions are satisfied.

According to such a detection system 100, it is possible to specify the range where the inclination of the structure has occurred, the damage scale, and the like according to the signals from the plurality of inclination sensors 1. In the inclination sensor 1 according to the embodiment of the present invention, since the power is supplied and notified only when inclination occurs, maintenance is easy, and thus a large number of inclination sensors can be installed in nature. Further, since the inclination sensor 1 is formed of a material that is naturally decomposed, a burden on the natural world is less likely to occur even if the inclination sensor 1 is not collected.

### (Configuration of Primary Battery and Electrode Reaction)

Here, each configuration of the primary battery 10 will be described.

The positive electrode 11 is formed of a conductive material used for a positive electrode of a general metal-air battery such as a carbon material. The positive electrode 11 can be produced by a known process such as molding carbon powder with a binder. In the primary battery, it is important to generate a large amount of reaction sites in the positive electrode 11, and thus the positive electrode 11 desirably has a high specific surface area. In a case where the positive electrode 11 is produced by molding carbon powder with a binder and pelletizing the carbon powder, when the specific surface area is increased, binding strength between the carbon particles becomes lower, and the structure deteriorates. Therefore, it is difficult for the positive electrode 11 to perform stable discharge, and discharge capacity decreases. Meanwhile, for example, in a case where the positive electrode 11 has a three-dimensional network structure, the positive electrode 11 does not need to use a binder, and the discharge capacity can be increased. Moreover, the positive electrode 11 may carry a catalyst. The catalyst is not particularly limited, but is favorably composed of at least one metal of Fe, Mn, Zn, Cu, and Mo, or a metal oxide consisting of at least one metal of Ca, Fe, Mn, Zn, Cu, and Mo. Among them, as the metal of the catalyst, one metal of Fe, Mn, and Zn, an oxide consisting of one of these metals, or a composite oxide consisting of two or more of these metals is favorable.

The negative electrode 13 is formed of a negative electrode active substance. The negative electrode 13 is formed of one or more metals selected from magnesium, zinc, aluminum, and iron, or an alloy containing, as a main component, one or more metals selected from magnesium, zinc, aluminum, and iron. The negative electrode 13 may be formed by a general method such as forming a metal or alloy plate or foil into a predetermined shape.

The electrolytic solution 22 contains an electrolyte. The type of electrolyte is not particularly limited as long as it is a substance capable of transferring metal ions and hydroxide ions between the positive electrode 11 and the negative electrode 13. The electrolyte is favorably composed of, for example, magnesium acetate, sodium chloride, potassium chloride, or the like. The electrolytic solution 22 is favorably neutral in consideration of environmental influence.

A known material can be used for the positive electrode current collector 12. For the positive electrode current collector 12, for example, a plate formed of any one or more of carbon sheet, carbon cloth, Fe, Cu, and Al may be used. A known material can also be used for the negative electrode current collector 14. In a case where a metal is used for the negative electrode 13, the primary battery 10 may be provided with no negative electrode current collector and the terminal may be directly taken out from the negative electrode 13 to the outside.

Here, electrode reactions in the positive electrode 11 and the negative electrode 13 in the primary battery using magnesium metal for the negative electrode 13 will be described. Oxygen in the air and the electrolyte come into contact with each other on the surface of the positive electrode 11 having conductivity, so that a positive electrode reaction represented by Formula (1) proceeds. Meanwhile, on the surface of the negative electrode 13 in contact with the electrolyte supplied by the separator 15, a negative electrode reaction represented by Formula (2) proceeds. Magnesium forming the negative electrode 13 emits electrons and is dissolved as magnesium ions in the electrolyte.

By the positive electrode reaction and the negative electrode reaction, the primary battery 10 can perform discharge. An overall reaction is a reaction in which magnesium hydroxide is generated (precipitated) as represented by Formula (3). Theoretical electromotive force is about 2.7 V.

$$[ Math . 1 ]$$

$$1 / 2 {O}_{2} + {H}_{2} O + 2 {e}^{-} \to 2 {OH}^{-} \qquad Formula ( 1 )$$

$$Mg \to {Mg}^{2 +} + 2 {e}^{-} \qquad Formula ( 2 )$$

$$Mg + 1 / 2 {O}_{2} + {H}_{2} O + 2 {e}^{-} \to {Mg ( OH )}_{2} \qquad Formula ( 3 )$$

### (Method for Generating Primary Battery)

A method for generating the primary battery 10 will be described. In the embodiment of the present invention, a carbon nanofiber is used for the positive electrode 11 to produce the primary battery 10.

First, a method for producing the positive electrode 11 will be described. A commercially available carbon nanofiber sol [dispersion medium: water (H₂O), 0.4 weight %, manufactured by Sigma-Aldrich Co. LLC.” was placed in a test tube, and the test tube was immersed in liquid nitrogen for 30 minutes to completely freeze the carbon nanofiber sol. After completely freezing the carbon nanofiber sol, the frozen carbon nanofiber sol was taken out into an eggplant flask and dried in a vacuum of 10 Pa or less by a freeze dryer (manufactured by Tokyo Rikakikai Co., Ltd.) to obtain a stretchable co-continuous body having a three-dimensional network structure including carbon nanosheets.

Next, a method for generating the negative electrode 13 will be described. The negative electrode 13 was produced by cutting a commercially available magnesium alloy plate AZ31B (thickness 300 μm, manufactured by Nippon Kinzoku Co., Ltd.) into a shape having a tab for current collection in a part of a square of 20 mm×20 mm using scissors.

As the electrolytic solution 22, a solution in which sodium chloride (NaCl, manufactured by Kanto Chemical Co., Inc.) was dissolved in pure water at a concentration of 1 mol/L was used. As the separator 15, a cellulose-based separator for battery (manufactured by Nippon Advanced Paper Industries Co., Ltd.) was cut into a square shape of 20 mm×20 mm and used.

A carbon cloth was used for the positive electrode current collector 12, and the positive electrode current collector was cut into a shape having a tab for current collection on a part of a square of 20 mm×20 mm and used. The positive electrode 11 was cut into a circular size having a diameter of 17 mm with a punch and used.

A method for generating the battery housing 16 will be described. The battery housing 16 is designed so that these can be accommodated within 30 mm×30 mm×10 mm. A polylactic acid (PLA) filament (manufactured by Raise 3D Technologies, Inc.) was dissolved and laminated by a Fused Filament Fabrication (FFF) method using Raise 3D Pro2 (manufactured by Raise 3D Technologies, Inc.) to create the battery housing 7. Note that a plurality of holes with Φ10 mm is provided as air holes in a bottom surface of the battery housing 16, specifically, a surface on the positive electrode 11 side.

The positive electrode current collector 12, the positive electrode 11, the separator 15, the negative electrode 13, and the negative electrode current collector 14 are stacked in this order from the bottom. The peripheral edge portions of the stacked portions are heat-sealed at 80° C. and sealed. After the sealed parts are disposed on the bottom surface of the battery housing 16, the water storage tank 21 containing the electrolytic solution 22 is installed thereon. Note that a mechanism for sealing the water storage tank 21 before use may be provided so that the electrolytic solution 22 does not come into contact with the separator 15 before installation in the structure.

### (Generation of Housing)

A method for generating the housing 20 will be described. As illustrated in FIG. 1, the housing 20 includes the primary battery 10 and the notification unit 30. The housing 20 is designed so that these can be accommodated within 100 mm×100 mm×50 mm. A polylactic acid (PLA) filament (manufactured by Raise 3D Technologies, Inc.) was dissolved and laminated by a Fused Filament Fabrication (FFF) method using Raise 3D Pro2 (manufactured by Raise 3D Technologies, Inc.) to create the housing 20. The PLA filament is formed of polylactic acid. Polylactic acid is a material that is naturally decomposed as described above, and therefore has a small burden on the environment.

### (Generation of Notification Unit)

A method for generating the notification unit 30 will be described. A LoRa/GPS tracker LT-100 (manufactured by GISUPPY) is improved so that power can be turned on and radio wave can be transmitted by driving the primary battery 10. The exterior of the LoRa/GPS tracker LT-100 is removed and stored in the housing 20. The LoRa/GPS tracker LT-100 is connected to the positive electrode current collector 12 and the negative electrode current collector 14 of the primary battery 10 in a non-power generation state.

Note that, since the cell voltage is assumed to be about 1.5 V, power boosted to 3.7 V by the DCDC circuit 35 is used.

### (Evaluation of Sensor)

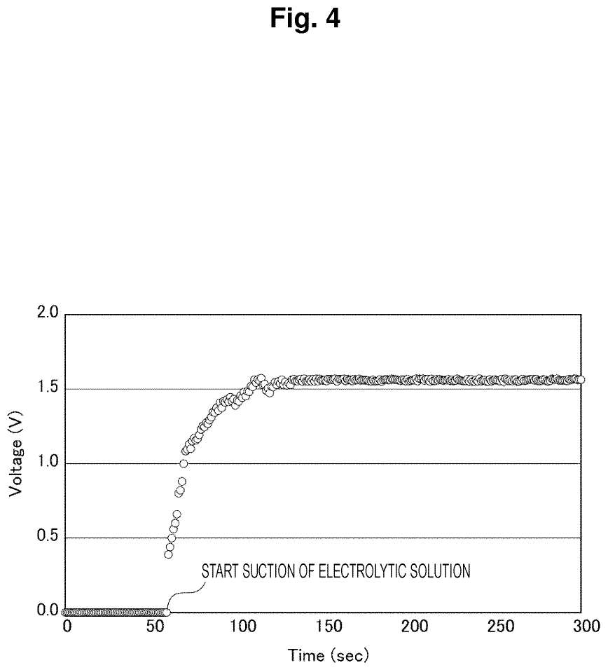

First, FIG. 4 illustrates a voltage change between the positive electrode 11 and the negative electrode 13 when the electrolytic solution is supplied to the separator 15.

When the electrolytic solution 22 was sucked up from the separator 15, the voltage rose and a stable voltage was obtained in about 150 seconds from the start of suction. The voltage at this time was about 1.5 V. After the stable voltage was obtained, the receiver confirmed the radio wave transmission from notification unit 30. Further, when the notification unit 30 transmitted the unique ID, the receiver also confirmed reception of this piece of information. The receiver is a receiver capable of receiving radio waves used in the LoRa/GPS tracker LT-100, and is a LoRa gateway ES 920 LRGW (manufactured by EASEL).

Further, when the sensor was installed in the soil after completion of the operation, decomposition of the housing was visually confirmed in about 2 months except for a commercially available circuit portion. It was shown that it was metabolized and decomposed by microorganisms in the soil.

In the inclination sensor 1 according to the embodiment of the present invention, the electrolytic solution 22 is leached to the separator 15 in contact with the positive electrode 11 and the negative electrode 13 due to the inclination of the housing 20 with the inclination of the structure, the primary battery 10 generates power, the primary battery 10 generates power, and the notification unit 30 is driven by the power generation of the primary battery 10 and can notify the inclination. The primary battery 10 of the inclination sensor 1 does not need to operate in normal times, and operates in a situation where inclination occurs and the notification unit 30 needs to perform notification. Therefore, the primary battery 10 does not self-discharge when not active, and can be operated for a long period of time such as, for example, over 10 years.

By forming each component such as the housing 20 with a material that can be naturally decomposed, there is no need to collect the components even if the components are installed in nature, and the burden on the environment is low. The inclination sensor 1 is installed in nature, and the detection server 102 installed at a position distant from the inclination sensor 1 receives the notification from the inclination sensor 1, so that it is possible to detect a disaster such as a mudslide occurring at a distant place. Further, the plurality of inclination sensors 1 is installed in a structure, and the detection server 102 receives a notification of inclination from these inclination sensors 1, so that it is possible to ascertain deterioration of the structure, a disaster scale, or the like without going to the site. Further, a business operator that manages the structure in which the inclination sensor 1 is installed cooperates with a transmission system of a local government or the like, so that it is possible to transmit an alarm to residents or the like.

For the detection server 102 and the database server 103 of the present embodiment described above, a general-purpose computer system including, for example, a central processing unit (CPU, a processor) 901, a memory 902, a storage 903 (a hard disk drive (HDD) or a solid state drive (SSD)), and a communication device 904, an input device 905, and an output device 906 is used. In the computer system, by the CPU 901 executing a predetermined program loaded on the memory 902, the functions of the detection server 102 and the database server 103 are implemented.

The detection server 102 and the database server 103 may each be implemented by one computer, or may be implemented by a plurality of computers. Furthermore, the detection server 102 and the database server 103 may each be a virtual machine mounted on a computer.

Each program of the detection server 102 and the database server 103 can be stored in a computer-readable recording medium such as an HDD, an SSD, a Universal Serial Bus (USB) memory, a compact disc (CD), or a digital versatile disc (DVD), or can be distributed via a network.

Note that the present invention is not limited to the above embodiment, and various modifications can be made within the scope of the gist of the present invention.

### REFERENCE SIGNS LIST

1 Inclination sensor
10 Primary battery
11 Positive electrode
12 Positive electrode current collector
13 Negative electrode
14 Negative electrode current collector
15 Separator
16 Battery housing
17 Positive electrode current collecting tab
18 Negative electrode current collecting tab
20 Housing
21 Water storage tank
22 Electrolytic solution
30 Notification unit
34 Communication antenna
31 Power supply circuit
32 Arithmetic circuit
33 Communication circuit
100 Detection system
101 Base station
102 Detection server
103 Database server
104 Monitoring device
901 CPU
902 Memory
903 Storage
904 Communication device
905 Input device
906 Output device

1. An inclination sensor comprising:
a notification unit configured to notify occurrence of inclination of a structure;
a water storage tank configured to contain an electrolytic solution; and
a primary battery including a positive electrode, a negative electrode, and a separator disposed between the positive electrode and the negative electrode, wherein,
when the water storage tank is inclined with the inclination of the structure, the electrolytic solution is injected into the separator, and the primary battery starts power generation and supplies power necessary for driving the notification unit.

2. The inclination sensor according to claim 1, further comprising: a plurality of the primary batteries connected in series.

3. The inclination sensor according to claim 1, wherein,
in a state where the inclination sensor is installed in the structure,
the water storage tank is installed above the primary battery, and an upper portion of the water storage tank is opened.

4. The inclination sensor according to claim 3, wherein
the primary battery is formed of the positive electrode, the separator, and the negative electrode in this order from a bottom, and
a size of a horizontal surface of the separator is formed to be larger than a size of the positive electrode.

5. The inclination sensor according to claim 1, wherein the negative electrode is formed of one or more metals selected from magnesium, zinc, aluminum, and iron, or an alloy containing, as a main component, one or more metals selected from magnesium, zinc, aluminum, and iron.

6. The inclination sensor according to claim 1, wherein the separator is formed of an insulator having water absorbency.

7. A detection system comprising:
the inclination sensor according to claim 1; and
a detection server connected to the inclination sensor, and configured to detect a notification of the inclination sensor and refer to a unique identifier of the inclination sensor and an installation position of the inclination sensor, wherein
the notification unit of the inclination sensor notifies the unique identifier of the inclination sensor, and
the detection server outputs a number of the notified unique identifiers and the installation position of the inclination sensor specified from the notified unique identifier.

8. The detection system according to claim 7, wherein
the detection server further refers to an inclination angle notifiable by the inclination sensor, the inclination angle being specified from a specification of a water storage tank of the inclination sensor and an amount of an electrolytic solution contained in the water storage tank, and
outputs the inclination angle notifiable by the inclination sensor specified from the unique identifier.
